(19) United States
(12) Patent Application Publication
(10) Pub. No.: US 2020/0245548 A1
(43) Pub. Date: Aug. 6, 2020

(54) HARVESTING MACHINE, SYSTEM, AND METHOD THEREOF

(71) Applicant: Mechanized Concepts, LLC, Lindon, UT (US)

(72) Inventors: Matthew Colledge, Cedar Hills, UT (US); Richard O. Evans, South Jordan, UT (US); Jaremy T. Butler, Russell, KS (US); Jesse T. Goulding, Lindon, UT (US); Tye A. Viehweg, American Fork, UT (US)

(21) Appl. No.: 16/676,430

(22) Filed: Nov. 6, 2019

Related U.S. Application Data
(60) Provisional application No. 62/757,538, filed on Nov. 8, 2018.

(51) Int. Cl. A01D 31/02; A01D 45/06; A01D 41/06; A01D 33/10; A01D 33/02; A01D 33/08; A01D 17/10

(52) U.S. Cl. CPC A01D 31/02; A01D 45/065; A01D 41/06; A01D 17/10; A01D 33/02; A01D 33/08; A01D 33/10

(57) ABSTRACT

Embodiments of a harvesting machine configured to uproot hemp plants and process various cut portions of the plants. The harvesting machine includes a harvesting head removably coupled to a main body of the harvesting machine. The harvesting head includes a roller positioned adjacent a lower front end of the harvesting head, the roller having tines extending therefrom and the roller configured to rotate so that the tines loosen soil and lift roots of the plants from the soil. The harvesting machine includes at least one belt positioned adjacently rearward of the roller and is configured to move the uprooted plants from the tines and to move the uprooted plants rearward from the harvesting head. Further, the harvesting head includes a cutting system positioned adjacent the at least one belt and is configured to make at least two cuts along a length of the plant to form the cut portions.

### CROSS-REFERENCE TO RELATED APPLICATIONS

This application claims the benefit of U.S. Provisional Application No. 62/757,538, filed Nov. 8, 2018, the disclosure of which is hereby incorporated by reference herein in its entirety.

### TECHNICAL FIELD

The present invention relates generally to farm equipment. More specifically, the present invention relates to farm equipment designed to harvest multiple different types of portions of a given plant.

### BACKGROUND OF THE INVENTION

In view of modern farming techniques, it is desirable to use machinery for the planting and harvesting of crops in order to reduce the amount of man power needed to farm a parcel of land. Use of machinery allows more land to be farmed while using less man power. The sophistication of these farming machines allows a single person to plant acres of crops in a short period of time. Likewise, the farming machines allow a single person to harvest acres of crops in a short period of time. However, the use of these farming machines is efficient and economical only when the machine is capable of harvesting the crops in a manner resulting in minimal damage to the crops.

Plants belonging to the family of hemp, especially the genus Hemp, have become a crop in demand due to their properties, for example, the roots, the seeds, and the highly fibrous stems all have unique and useful properties. For example, the hemp fibers are suitable for papermaking, textiles, clothing, biodegradable plastics, biofuel and many other uses. Oil can be obtained from the seeds, which can serve as basis for multiple products. Further, the properties from the roots hold various medical uses. The challenge is harvesting the entire plant without damaging the various components of the crop. As such, it would be desirable to effectively and efficiently harvest multiple portions of the hemp plant, or the entire hemp plant, to maximize the yield from the desired portions of the hemp plant.

### SUMMARY OF THE INVENTION

Embodiments of the present invention are directed to a harvesting machine configured to uproot hemp plants and process various cut portions of the plants. In one embodiment, the harvesting machine includes a main body, a harvesting head, at least one belt and a cutting system. The main body includes an engine and a control system, the main body extending between a front side, a rear side, a first side and a second side thereof. The harvesting head is configured to be removably coupled to the front side of the main body. The harvesting head includes a roller positioned adjacent a lower front end of the harvesting head. The roller includes tines extending therefrom such that the roller is configured to rotate so that the tines loosen soil and lift roots of the plants from the soil. The at least one belt is positioned adjacently rearward of the roller such that the at least one belt is configured to move the uprooted plants from the tines and to move the uprooted plants rearward from the harvesting head. The cutting system is positioned adjacent the at least one belt, the cutting system being operatively coupled to and controlled by the control system and configured to make at least two cuts along a length of the plant to form the cut portions.

In another embodiment, the harvesting machine further includes a separating system configured to be operatively coupled to and controlled by the control system, the separating system is configured to separate a first type of the cut portions of the plants from a second type of the cut portions of the plants. In another embodiment, the harvesting machine further includes an unloading system configured to move a first type of the cut portions of the plants away from the main body and into a first container and is configured to move a second type of the cut portions of the plants away from the main body. In another embodiment, the harvesting machine includes a vibrating component associated with the main body, the vibrating component configured to vibrate to assist removing excess soil from the roots of the plants.

In another embodiment, the harvesting head includes a second roller positioned adjacent the lower front end of the harvesting head, the second roller having tines extending therefrom such that the tines are configured to loosen soil and lift roots of the plants from the soil. In still another embodiment, the harvesting machine further includes a rear trailer configured to be removably coupled to the rear side of the main body. In yet another embodiment, the at least one belt extends along the harvesting head and rearward along the main body. In another embodiment, the main body includes a side chute extending from the main body.

In accordance with another embodiment of the present invention, a harvesting machine configured to uproot hemp plants and process various cut portions of the plants is provided. The harvesting machine includes a main body, a harvesting head, at least one belt, and a cutting system. The main body includes an engine and a control system, the main body extending between a front side, a rear side, an upper side, a lower side, a first side and a second side of the main body. The engine of the main body facilitating mobility of the main body. The harvesting head is configured to be removably coupled to the front side of the main body. Further, the harvesting head includes rotating structure adjacent a front side thereof, the rotating structure being sized and configured to draw roots of the plants from soil. The at least one belt is positioned adjacently rearward of the rotating structure, the at least one belt configured to move the uprooted plants from the rotating structure to move the uprooted plants rearward from the harvesting head. The cutting system is positioned adjacent the at least one belt, the cutting system being operatively coupled to and controlled by the control system and is configured to make at least two cuts along a length of the plant to form the cut portions.

In another embodiment, the harvesting machine further includes a separating system configured to be operatively coupled to and controlled by the control system, the separating system configured to separate a first type of the cut portions of the plants from a second type of the cut portions of the plants. In another embodiment, the harvesting machine further includes an unloading system configured to move a first type of the cut portions of the plants away from the main body and into a first container and configured to move a second type of the cut portions of the plants away from the main body. In another embodiment, the harvesting machine further includes a vibrating component associated with the main body, the vibrating component configured to vibrate to assist removing excess soil from the roots of the plants.

In another embodiment, the rotating structure includes at least one roller with tines extending therefrom. In still another embodiment, the at least one roller extends and is positioned adjacent a lower front end of the harvesting head. In another embodiment, the at least one belt extends along the harvesting head and rearward along the main body.

In another embodiment, the harvesting machine further includes a rear trailer configured to be removably coupled to the rear side of the main body. In another embodiment, the main body includes a side chute extending from the main body.

In accordance with another embodiment of the present invention, a method of harvesting hemp plants and processing various cut portions of the hump plants is provided. The method steps include: pulling roots of the plants from the soil with rotating structure along a front side of a harvesting head removably coupled to a front side of a harvesting machine; moving the uprooted plants from the rotating structure with at least one belt to move the uprooted plants rearward from the harvesting head; and making at least two cuts along a length of the uprooted plants with a cutting system of the harvesting machine to form the cut portions.

In another embodiment, the method further includes the step of separating a first type of the cut portions of the plants from a second type of the cut portions and moving at least one of the first type and the second type of the cut portions to one or more containers. In another embodiment, the separating step includes the step of separating a third type of the cut portions of the plants. In another embodiment, the method further includes the step of moving a first type of the cut portions of the plants away from the main body and into a first container and moving a second type of the cut portions of the plants away from the main body.

In another embodiment, the method further includes the step of loosening soil with the harvesting head prior to pulling the roots of the plants from the soil. In still another embodiment, the loosening step further includes the step of loosening soil with tines extending from a roller of the rotating structure. In another embodiment, the method further includes the step of vibrating the roots of the plants with a vibrating component coupled to the harvesting machine to remove the soil from the roots.

In accordance with another embodiment of the present invention, a harvesting system configured to uproot entire plants and process various portions of the plants is provided. The harvesting system includes a main body extending to define a lower body portion, an upper body portion, a front body portion, a rear body portion, a first side body portion and a second side body portion. The lower body portion is configured to facilitate mobility of the main body. Further, the main body includes a cab, a harvesting head, an upward extending belt, a generally extending horizontal belt, blades and a rear material processing portion. The cab is positioned at the upper body portion and includes a control system configured to control functions of the main body. The harvesting head includes rotatable tines and two upright belts positioned behind the rotatable tines. The harvesting head is removably coupled to the front body portion of the main body. Further, the harvesting head includes a lower leading portion with the rotatable tines such that the rotating tines are configured to lift the plants from the ground to be positioned upright against the two upright belts. The two upright belts are configured to move the upright plants inward to a central portion of the harvesting head. The upward extending belt extends at an angle from the central portion to the upper body portion adjacent to a front side of the cab such that the upward extending belt includes a rail and roller arrangement to facilitate moving and maintaining the plants in a generally upright position. The generally horizontal belt extend from the upward extending belt and alongside of the cab toward the rear body portion of the main body, the horizontal belt associated with a vibration device configured to remove soil from the roots of the plants. The blades are positioned adjacent and above an end portion of the horizontal belt such that the blades are sized and configured to cut roots from the stalks and to cut the stalks to predetermined lengths. The rear material processing portion is sized and configured to receive the roots along a lower belt system and sized and configured to receive the cut stalks along a second lower belt, the lower belt configured to funnel the roots to a first boom and the second lower belt configured to move the stalks through a bundling process to form stalk bales to then be conveyed through a side chute extending from the rear material processing compartment.

In one embodiment, the harvesting system further includes a rear trailer removably coupled to the rear body portion of the main body, the rear trailer including one or more containers for receiving plant material from the first boom. In another embodiment, the rotatable tines are configured to reversibly rotate so that the tines move through the soil, under the plants, to lift the plants above the rotatable tines in an upright manner.

In another embodiment, the rear material processing portion includes a chopping system configured to cut the roots into more uniformly sized root pieces. In yet another embodiment, the rear material processing portion is configured to bundle the stalks into a cylindrical bale with an axis of the cylindrical bale extending generally parallel with the stalks. In still another embodiment, the blades are configured to cut a top portion of the plants having leaf material and seed therewith such that the leaf material and seed drop onto an upper belt to be conveyed into the rear material processing portion to be funneled into a second boom.

In accordance with another embodiment of the present invention, a method for harvesting a whole plant including roots of the plant is provided. The method includes the steps of: providing a harvesting machine having a main body with a lower body portion facilitating mobility of the main body; driving the harvesting machine in a field to harvest the plants therein such that the harvesting machine includes a control system within a cab of the harvesting machine, the control system configured to control functions of the harvesting machine; rotating tines at a leading edge of a harvesting head to lift the roots and the whole plant upward and behind the rotating tines such that stalks of the plants are positioned upright against a moving belt system of the harvesting head, the moving belt system having two inwardly moving upright belts to move the upright positioned plants inward to an upward extending belt; moving the plants in the upright position between oppositely positioned rollers and rails along the upward extending belt to an upper body portion of the main body; vibrating the plants along a generally horizontal belt to substantially remove soil from the roots of the upright positioned plants; cutting the roots from stalks of the plant and cutting the stalks to predetermined lengths; moving the stalks to bundle and form stalk bales to then proceed through a side conveyer output; moving the seed or leaf to a first boom to empty into a first compartment of a rear trailer, the rear trailer removably coupled to the main body of the harvesting machine; and moving the roots to a second boom to empty into a second compartment of the rear trailer.

In another embodiment, the method further includes, after cutting the roots from the stalks, chopping the roots into smaller pieces for a denser material stream to then move through the second boom. In another embodiment, the method further includes the step of pressing resin out of stalks through rollers prior to bundling and baling the stalks.

In accordance with another embodiment of the present invention, a method of harvesting an entire plant from soil is provided. The method includes the steps of: lifting the plant with roots from the soil with rotating tines at a leading edge of a harvesting machine; gathering the plants with two inwardly moving belts to a rearward moving beltway; vibrating the plants to remove the soil from the roots with stalks of the plant in an upright position with the plants moving along a belt; separating the roots from the stalks of the plants with a cutting system; bundling the stalks to form stalk bales for discarding from the harvesting machine; and moving the roots along the beltway to a container.

In another embodiment, the method further includes chopping the roots to smaller pieces to form denser root material prior to the beltway moving the roots into the container. In still another embodiment, the method further includes pressing resin from the stalks with a roller pressing system prior to the stalks being formed in stalk bales.

In another embodiment, the separating step includes separating a top portion of the plant having seeds and leaf material with the cutting system. In another embodiment, the method further includes moving the seeds and leaf material along the beltway to one or more other containers. In still another embodiment, the method step of moving the seeds and leaf material includes moving the seeds and leaf material through one or more booms to be emptied into the one or more containers. In yet another embodiment, the method further includes moving the root material through a boom to be emptied into the container. In another embodiment, wherein the plants are maintained in a substantially upright position during the steps of lifting, gathering, vibrating and separating.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a perspective front view of a harvesting machine, according to an embodiment of the present invention;

FIG. 2 is a front view of the harvesting machine of FIG. 1, according to another embodiment of the present invention;

FIG. 3 is a front view of a roller of an uprooting portion of the harvesting machine, depicting an orientation of the tines extending from the roller of the uprooting portion, according to another embodiment of the present invention;

FIG. 4 is a top view of the harvesting machine of FIG. 1, according to another embodiment of the present invention;

FIG. 5 is a left side view of the harvesting machine of FIG. 1, according to another embodiment of the present invention;

FIG. 6 is a right side view of the harvesting machine of FIG. 1, according to another embodiment of the present invention;

FIG. 7 is a rear perspective view of the harvesting machine of FIG. 1, according to another embodiment of the present invention;

FIG. 8 is a rear view of the harvesting machine of FIG. 1, according to another embodiment of the present invention; and

FIG. 9 is a schematic view of the harvesting machine of FIG. 1, according to another embodiment of the present invention.

### DETAILED DESCRIPTION OF THE INVENTION

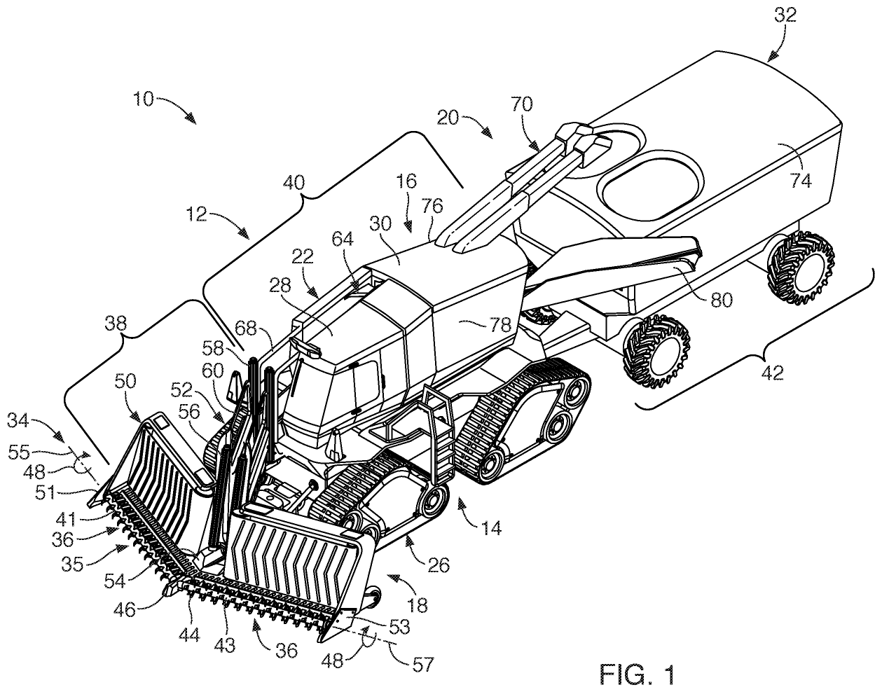

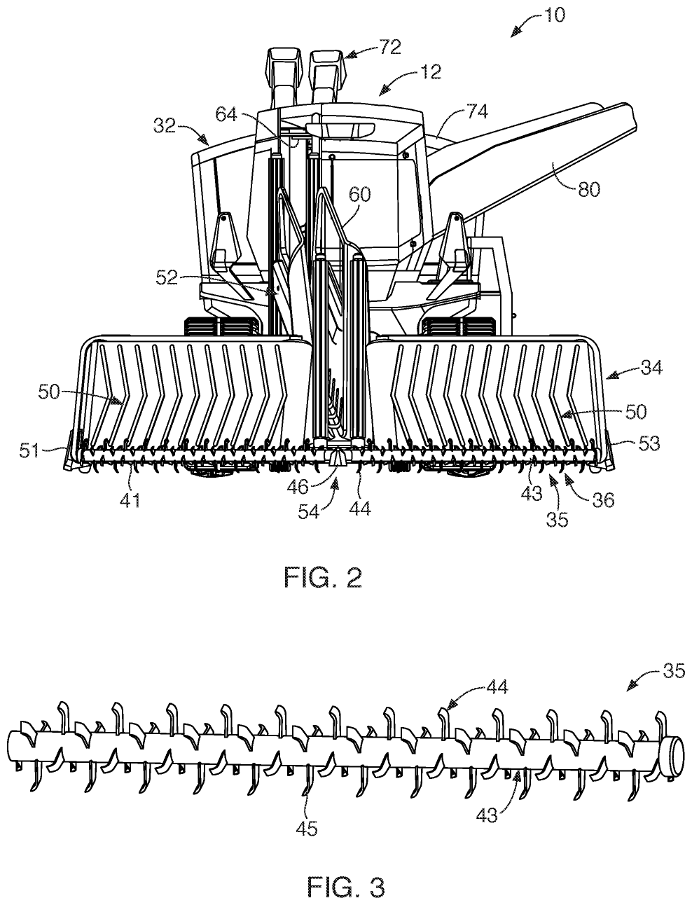

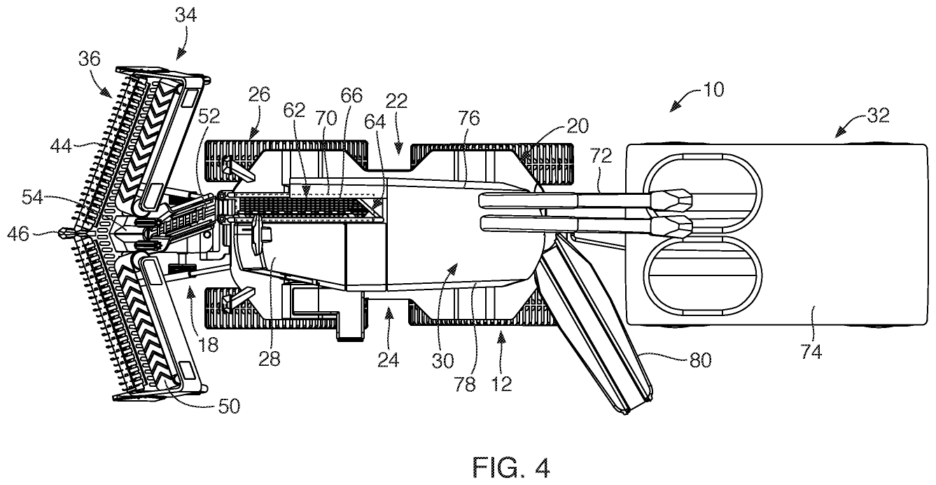

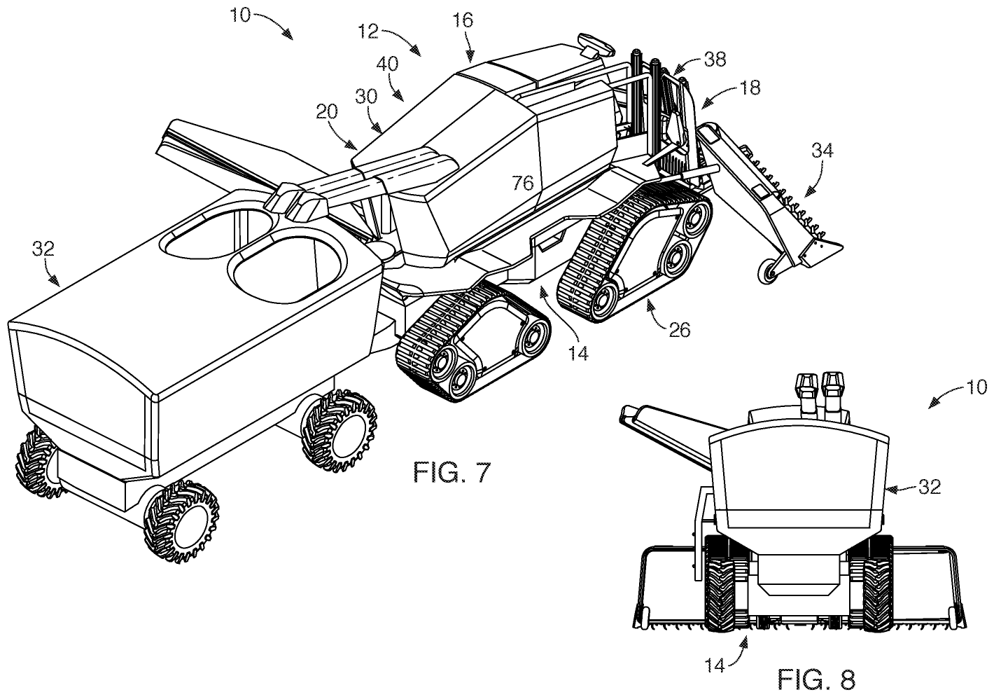

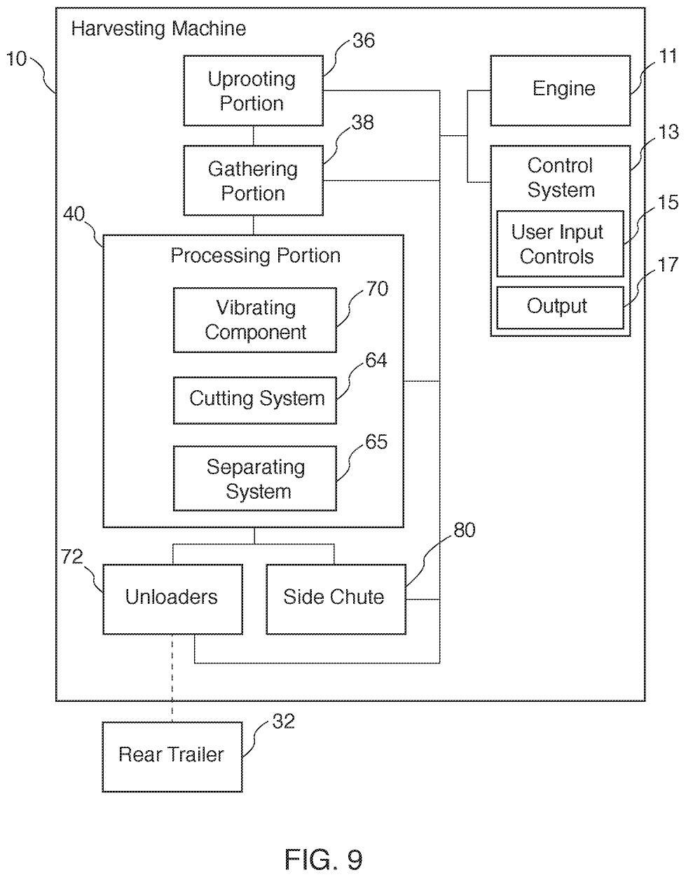

Referring to FIGS. 1 through 9, a harvesting machine 10 sized and configured to harvest entire plants (not shown), such as hemp plants or any other suitable tall upward extending plants, is provided. Hemp plants can typically grow most anywhere between 6-10 feet tall each with a single main stalk that extends generally vertically with a concentration of leaf material and seed at a top portion of the plant. Each of the roots, stalk, leafy material and seed of the hemp plant are harvestable components with valuable properties. For example, the collected seeds may be utilized for food, oil extraction, or for replanting. The collected leafy material may be employed for livestock feed. The stalk from the formed stalk bales may be further processed for structural materials and textiles. The root material may be further processed for the extraction of CBG (cannabigerol) or CBD (cannabidiol) therefrom and/or other compounds.

The harvesting machine 10 may include an engine 11 and a control system 13 for driving and controlling various components and functions of the harvesting machine 10. For example, the harvesting machine 10 includes various components and functions for uprooting a substantial entirety of the plants from the soil, gathering or funneling the plants to and along a beltway extending along and through the harvesting machine 10, and cutting and separating various portions of the plants to then be processed and funneled to containers, such as the root material, leaf material, and seed, with other portions of the plants, such as the stalks, to be processed and bundled into stalk bales or discarded loosely from the harvesting machine. In this manner, the harvesting machine 10 set forth herein may be employed for harvesting the entirety of the hemp plants with processing and collection functions associated with the harvesting machine to, thereby, limit waste of the plants and utilize most all the valuable resources found in various portions and components of the plants. In another embodiment, the harvesting machine 10 may be employed for harvesting at least two or more of the components of the hemp plant. In another embodiment, the harvesting machine 10 may be employed for harvesting at least the roots of the hemp plant and one or more other components of the plant, such as the stalks, leafy material, or seeds. Such harvesting machine 10 may be sized and configured to simultaneously and consecutively harvest large quantities (into separated components) of the hemp plant over a limited amount of time to maximize the yield from the hemp plant within a given track of land. Further, the harvesting machine can be made from high strength metallic materials, such as steel and other suitable metallic materials, and various high strength polymeric materials that may be typical for harvesting machines in the industry as known to one of ordinary skill in the art. Also, the various components of the harvesting machine, as set forth herein, may be made and formed using typical processes and manufacturing techniques known in the art.

The harvesting machine 10 may include a main body 12 sized and configured to house the engine 11 and the control system 13, the main body 12 extending to define a lower body portion 14, an upper body portion 16, a front body portion 18, a rear body portion 20, a first side body portion 22 and a second side body portion 24 (see FIG. 3). The engine 11 may include various components typical to harvesting machine engines, such as a power source, fuel tank, transmission, and any other components as known by one of ordinary skill in the art. The engine 11 may be associated with a power take-off (“PTO”) system and hydraulic system with multiple sub-systems with the appropriate mating drive shafts and hydraulic cables incorporated therewith sized and configured to power and drive various functions of the harvesting machine 10, as known by one of ordinary skill in the art. Further, such various functions of the harvesting machine 10 driven by the engine 11 and the PTO system may be controlled by the control system 13. The control system 13 may include pre-programmed or programmable functions for controlling functional aspects of the harvesting machine 10 and may include user input controls 15 in the form of a control panel and, for example, an output 17 that may be in the form of a screen display. The various components of the control system may be typical components in harvesting machine technology as known by one of ordinary skill in the art.

The lower body portion 14 of the harvesting machine 10 may facilitate mobility of the harvesting machine 10 with, for example, track wheels 26 or any other suitably sized wheels or the like. The upper body portion 16 of the harvesting machine 10 may include a cab 28 positioned along the second side body portion 24 and along the upper body portion 16. The cab 28 may include the user input controls 15 and the output 17 of the control system 13 configured to control various systems and functional components of the harvesting machine 10, including components for driving the harvesting machine 10, as previously set forth. Further, the upper body portion 16 may include various systems for processing the plants, discussed further herein, that may be positioned along the first side body portion 22 and along the upper body portion 16. The rear body portion 20 may include an at least partially enclosed rear material processing portion 30 with multiple sections for processing the different separated portions of the plant, discussed further herein. The rear body portion 20 may also be removably coupled to a rear trailer 32. The front body portion 18 may be removably coupled to a head portion or harvesting head 34.

Further, as set forth, the harvesting machine 10 employs various systems, components and functions for harvesting most, if not all, portions of the hemp plant. The harvesting machine 10 may include four main functional processing/harvesting portions: an uprooting portion 36, a gathering portion 38, a processing portion 40, and a collection portion 42, each of which may be driven by the engine 11 and controlled by the control system 13.

With reference to FIGS. 1-3, the uprooting portion 36 of the harvesting machine 10 may be positioned along or adjacent a lower leading portion 46 of the harvesting head 34. In one embodiment, the uprooting portion 36 may include rotating structure 35 that may be positioned along a front lower side of the harvesting head 34. Such rotating structure 35 may be sized and configured to lift, draw or pull roots of a plant from loosened soil. In another embodiment, the uprooting portion may include one or more lower rollers, such as a first roller 41 and a second roller 43, each extending along first and second sides of the lower leading portion 46 of the harvesting head 34. In another embodiment, the first and second rollers 41, 43 may extend between the lower leading portion 46 and first and second side structure 51, 53 of the harvesting head 34. For example, the first roller 41 may extend between the lower leading portion 46 and the first side structure 51 so as to define a first axis 55. Similarly, the second roller 43 may extend between the lower leading portion 46 and the second side structure 53 to define a second axis 57.

In one embodiment, the first and second axes 55, 57 of the respective first and second rollers 41, 43 may be transverse relative to each other so as to exhibit a v-profile, the lower leading portion 46 being at a point of the v-profile. As such, the first and second rollers 41, 43 and the front side of the harvesting head 34 may exhibit the v-profile. Each of the first and second rollers 41, 43 may be rotatably coupled at their respective ends such that the first and second rollers 41, 43 may be sized and configured to rotate. Further, the first and second rollers 41, 43 may include tines 44 extending radially from the first and second rollers 41, 43 or extending radially relative to the first and second axes 55, 57. The tines 44 may be fixedly coupled to the first and second rollers 41, 43 or may be removably coupled to the first and second rollers 41, 43 if replacement tines 44 are needed. Further, the tines 44 may extend from the first and second rollers 41, 43 with a j-shaped configuration such that the tines 44 may curve inward toward the central connection along end portions of each of the respective tines 44 (see FIG. 3). The tines 44 may be coupled to each of the first and second rollers 41, 43 in longitudinal rows so as to extend directly from the outer surface of each of the first and second rollers 41, 43. Further, the tines 44 may extend from each of the first and second rollers 41, 43 such that the tines 44 of one row are off-set along a longitudinal length of the respective roller relative to an adjacent longitudinal row of tines 44. In another embodiment, each of the first and second rollers 41, 43 may exhibit six longitudinal rows of tines, the tines of one row being off-set relative to the tines of an adjacent row of tines.

The first and second rollers 41, 43 may rotate about the respective first and second axes 55, 57 in a reverse direction, as shown by rotational arrow 48, so that the tines 44 can be rotated and move through the soil so as to loosen the soil and lift and push the plant roots from below the ground surface to keep the roots of the plant substantially intact with the stalk of the plant. In this manner, as the tines 44 rotate in the reverse direction, the tines 44 loosen the soil so that an edge 45 (or side profile) of the tines 44 may lift the plant roots from the loosened soil and move the plants behind or rearward of the tines 44 toward the gathering portion 38. With this arrangement, the harvesting machine 10 may by employed to uproot entire hemp plants simultaneously and consecutively as the harvesting machine 10 moves forward within a field of the plants so that the various components or portions of the hemp plants may be cut, separated, and harvested as desired.

With reference again to FIGS. 1, 2 and 4, the gathering portion 38 of the harvesting machine 10 may be disposed adjacently above and rearward of the rotating tines 44 along the front body portion 18 of the main body 12 and may extend to the upper body portion 16 of the main body 12. The gathering portion 38 may include at least one belt system. For example, the gathering portion 38 may include one or more upright belt systems, such as two upright belt systems 50, and an upward extending belt system 52. In one embodiment, one of the upright belt systems may correspond with the first roller 41 and the other upright belt system may correspond with the second roller 43. The two upright belt systems 50 may each include rollers and a continuous belt such that the rollers may be driven to rotate and move a front facing surface of the belts toward a central portion 54 of the harvesting head 34. In this manner, as the plants are lifted from the soil by the tines 44 of the first and second rollers 41, 43, the plants remain generally upright and contact the front facing surface of the two upright belt systems 50, which move the plants inward and toward the central portion 54 of the harvesting head, thereby funneling and gathering the plants toward the upward extending belt.

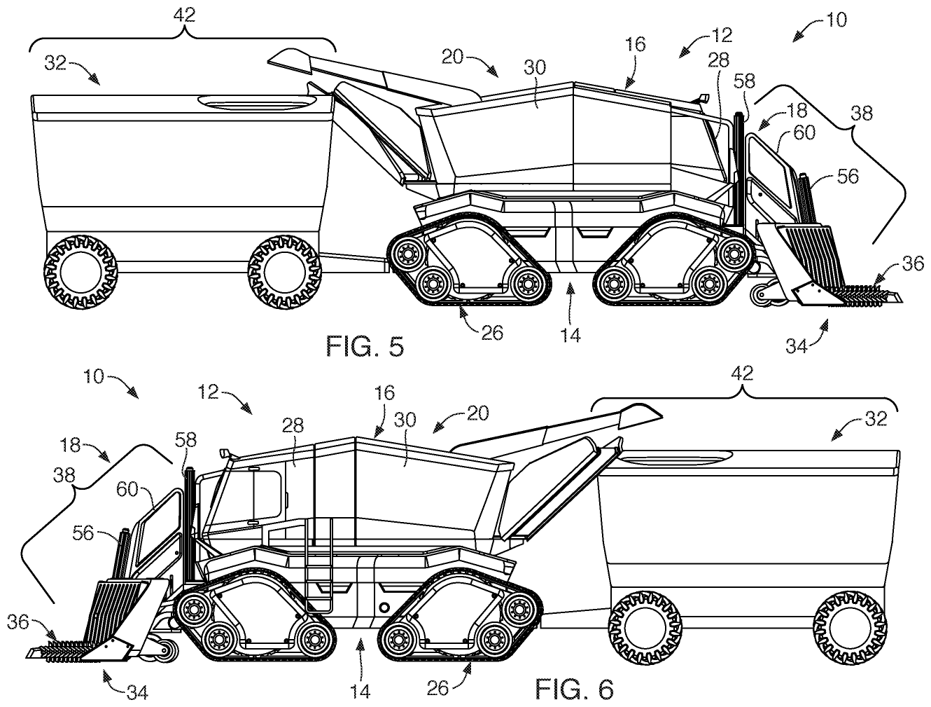

Once the plants move to the central portion 54 of the harvesting head 34, the plants may then be funneled along the upward extending belt system 52 to the upper body portion 16 of the main body 12. Such upward extending belt system 52 may extend upward at an angle to the upper body portion 16. The upward extending belt system 52 may include a first pair of vertical rollers 56, oppositely positioned, at the bottom of the upward extending belt system 52 and a second pair of vertical rollers 58, oppositely positioned at a top end of the upward extending belt system 52. The upward extending belt system 52 may also include rails 60 extending between the first and second pair of vertical rollers 56, 58 (see FIGS. 5 and 6). Each of the first and second pair of vertical rollers 56, 58 may be sized and configured to rotate so and cooperate with each other so as to pull and funnel the plants forward in the upright position. For example, each vertical roller on the right side of the first and second pairs of vertical rollers 56, 58 may rotate clockwise and each vertical roller on the left side of the first and second pairs of vertical rollers 56, 58 may rotate counter-clockwise. In one embodiment, the first and second pair of vertical rollers 56, 58 may include traction nubs or ribs sized and configured to pull and funnel the plants upward along the upward extending belt system 52. In another embodiment, the first and second pair of vertical rollers 56, 58 may include rods spaced apart and extending radially from longitudinal axes of the vertical rollers 56, 58. The upward extending belt system 52 may include a beltway along a floor of the upward extending belt system 52 and/or a pair of beltways vertically oriented along the side walls of the upward extending belt system between, for example, upper and lower ones of the rails 60. In this manner, the upward extending belt system 52, with its first and second pairs of vertical rollers 56, 58, beltways and/or rails 60 may assist in the flow of the plants and assist in the plants being maintained in an upright position upon reaching the top end of the upward extending belt system 52. In this manner, the gathering portion 38 of the harvesting machine 10 may gather and funnel the previously uprooted plants to the central portion 54 of the harvesting head 34 via the two upright belt systems 52. The plants may then be funneled, while in the upright position, to then continue moving upward along the upward extending belt system 52 to the upper body portion 16 of the harvesting machine 10.

With reference to FIGS. 1, 2, 4, and 9, the processing portion 40 of the harvesting machine 10 may extend from the upper end of the upward extending belt system 52 to be positioned along the upper body portion 16 and the rear body portion 20 of the main body 12. The processing portion 40 may be positioned adjacent to and include a generally horizontal belt system 62 (FIG. 3) extending to the rear material processing portion 30 of the harvesting machine 10. Further, the processing portion may include a vibrating component (shown generally as a vibrating region 70 with dashed lines in FIG. 3), a cutting system 64, and a separating system 65. The vibrating component may extend along an underside of a horizontal belt 66 of the horizontal belt system 62. The cutting system 64 may be positioned above the horizontal belt system adjacent a front side of the rear body portion 30. The cutting system may include other cutting components at various heights and further rearward in the rear body portion 30. With this arrangement, as the plants move along the horizontal belt system 62, the plants may be maintained in the upright position with upper rails 68 extending along and above both sides of the horizontal belt 66. With the plants in the upright position, the roots of the plants may be positioned directly on the surface of the horizontal belt 66. The vibration component may be sized and configured to vibrate the surface of the horizontal belt to vibrate within the vibration region 70, as shown in dashed lines, so that loose soil remaining on the roots may fall from the roots and be discarded. As the upright positioned plants continue to move down the horizontal belt 66 and past the vibration region 70, the plants may then be separated into various portions or components with the cutting system 64.

The cutting system 64 may include multiple blades to make cuts at different predetermined heights along the length of the plant. For example, the cutting system 64 may cut the top portion of the plant from the stalk for processing seed and leaf material. Further, the cutting system 64 may cut the roots from the stalks to process the root material. The cutting system may also cut the stalks to multiple predetermined lengths. In one embodiment, the cutting system 64 may include a stabilizer (not shown) sized and configured to stabilize the plants while the plants are being cut with the cutting system.

Upon the cutting system 64 cutting the leaf and seed material from the stalks, the leaf and seed material may fall onto the horizontal belt 66 or an upper platform or belt (not shown). The leaf and seed material may then be separated and moved or funneled to, for example, a first side 76 of the rear material processing portion 30 and then drawn through an unloader 72 or one or more booms. The separating system 65 may include one or more pusher members and/or beltways to separate the cut leaf and seed material to the desired location to feed into one of the unloaders 72. In another embodiment, the separating system 65 may include various screens for catching seeds as the leaf material is moved with the pusher members. As the leaf material is moved toward and drawn into one of the unloaders 72, the leaf material may be funneled to one of the containers 74 of the rear trailer 32 or the collecting portion 42.

Upon the cutting system 64 cutting the roots from the stalks, the roots may fall on the horizontal belt within the rear material processing portion and/or may then be separated with one or more pusher members or beltways of the separating system 65 to move the roots to a lower belt or lower platform (not shown). At, for example, the lower platform, the roots may be further cut with a chopping component of the cutting system to cut and chop the roots into smaller minimized pieces so as to be diced or formed into root material. In this manner, the root material may be minimized to a more uniform size to facilitate denser collection of the root material. Such root material may then be delivered to and through one of the booms or unloaders 72 and then to one of the containers 74 of the rear trailer 32 or the collecting portion 42.

Once the leafy material and roots are removed from the stalks, the stalks may then be processed. In one embodiment, the stalks may be left alone without further cuts and moved with a pusher member of the separating system 65 or funneled to, for example, a second side 78 of the rear material processing portion 30. In another embodiment, the stalks may be cut with the cutting system 64 into multiple predetermined lengths to then be moved to a second lower belt (not shown) to diverge to the second side 78 of the rear material processing portion 30. In one embodiment, the stalks may be manipulated to be pressed through rollers (not shown) to press resin from the stalks within the rear material processing portion 30. The stalks may then be bundled to form stalk bales. The stalk bales may be moved from the rear material processing portion 30 through a side chute 80 of the harvesting machine 10 so that the stalk bales can be discarded from the chute to the ground or collected on another trailer (not shown) alongside the harvesting machine 10. The stalk bales formed in the second side 78 of the rear material processing portion 30 of the harvesting machine 10 may be formed in a cylindrical structure such that an axis of the cylindrical structure extends generally parallel with the longitudinal length of the stalks in the cylindrical structure. In another embodiment, the stalks, as single uncut stalks or stalks cut into multiple predetermined lengths, may be moved through rollers to press resin from the stalks and then funneled through the side chute to be discarded in a loose manner from the harvesting machine 10. With this arrangement, the cutting system may act in concert with the separating system 65 so that as portions of the plant are cut, the pusher members and/or beltways of the separating system 65 may separate and move the various portions of the plant to be funneled through the appropriate unloader 72 or side chute so that the various portions of the plant can effectively be moved into separate containers.

With this arrangement, the harvesting machine 10 may be employed for harvesting large tracks of land of the hemp plant in a continuous and simultaneous/consecutive manner. Further, as set forth, the harvesting machine may include various functions and systems to facilitate removing the hemp plants with the roots and processing the major components of the hemp plant to maximize the yield of the hemp plant in a given track of land.

While the invention may be susceptible to various modifications and alternative forms, specific embodiments have been shown by way of example in the drawings and have been described in detail herein. Further, the structural features of any one embodiment disclosed herein may be combined or replaced by any one of the structural features of another embodiment set forth herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A harvesting machine configured to uproot hemp plants and process various cut portions of the plants, the harvesting machine comprising:
a main body having an engine and a control system, the main body extending between a front side, a rear side, a first side and a second side thereof;
a harvesting head configured to be removably coupled to the front side of the main body, the harvesting head having a roller positioned adjacent a lower front end of the harvesting head, the roller having tines extending therefrom, the roller configured to rotate so that the tines loosen soil and lift roots of the plants from the soil;
at least one belt positioned adjacently rearward of the roller, the at least one belt configured to move the uprooted plants from the tines and to move the uprooted plants rearward from the harvesting head; and
a cutting system positioned adjacent the at least one belt, the cutting system operatively coupled to and controlled by the control system and configured to make at least two cuts along a length of the plant to form the cut portions.

2. The harvesting machine of claim 1, further comprising a separating system configured to be operatively coupled to and controlled by the control system, the separating system configured to separate a first type of the cut portions of the plants from a second type of the cut portions of the plants.

3. The harvesting machine of claim 1, further comprising an unloading system, the unloading system configured to move a first type of the cut portions of the plants away from the main body and into a first container and configured to move a second type of the cut portions of the plants away from the main body.

4. The harvesting machine of claim 1, further comprising a vibrating component associated with the main body, the vibrating component configured to vibrate to assist removing excess soil from the roots of the plants.

5. The harvesting machine of claim 1, wherein the harvesting head comprises a second roller positioned adjacent the lower front end of the harvesting head, the second roller having tines extending therefrom such that the tines are configured to loosen soil and lift roots of the plants from the soil.

6. The harvesting machine of claim 1, further comprising a rear trailer configured to be removably coupled to the rear side of the main body.

7. The harvesting machine of claim 1, wherein the at least one belt extends along the harvesting head and rearward along the main body.

8. The harvesting machine of claim 1, wherein the main body includes a side chute extending from the main body.

9. A harvesting machine configured to uproot hemp plants and process various cut portions of the plants, the harvesting machine comprising:
a main body having an engine and a control system, the main body extending between a front side, a rear side, an upper side, a lower side, a first side and a second side thereof, the engine of the main body facilitating mobility of the main body;
a harvesting head configured to be removably coupled to the front side of the main body, the harvesting head including rotating structure sized and configured to draw roots of the plants from soil;
at least one belt positioned adjacently rearward of the rotating structure, the at least one belt configured to move the uprooted plants from the rotating structure to move the uprooted plants rearward from the harvesting head; and
a cutting system positioned adjacent the at least one belt, the cutting system operatively coupled to and controlled by the control system and configured to make at least two cuts along a length of the plant to form the cut portions.

10. The harvesting machine of claim 9, further comprising a separating system configured to be operatively coupled to and controlled by the control system, the separating system configured to separate a first type of the cut portions of the plants from a second type of the cut portions of the plants.

11. The harvesting machine of claim 9, further comprising an unloading system, the unloading system configured to move a first type of the cut portions of the plants away from the main body and into a first container and configured to move a second type of the cut portions of the plants away from the main body.

12. The harvesting machine of claim 9, further comprising a vibrating component associated with the main body, the vibrating component configured to vibrate to assist removing excess soil from the roots of the plants.

13. The harvesting machine of claim 9, wherein the rotating structure comprises at least one roller with tines extending therefrom.

14. The harvesting machine of claim 13, wherein the at least one roller extends and is positioned adjacent a lower front end of the harvesting head.

15. The harvesting machine of claim 9, further comprising a rear trailer configured to be removably coupled to the rear side of the main body.

16. The harvesting machine of claim 9, wherein the at least one belt extends along the harvesting head and rearward along the main body.

17. The harvesting machine of claim 9, wherein the main body includes a side chute extending from the main body.

18. A method of harvesting hemp plants and processing various cut portions of the hemp plants, the method comprising:
pulling roots of the plants from the soil with rotating structure along a front side of a harvesting head removably coupled to a front side of a harvesting machine;
moving the uprooted plants from the rotating structure with at least one belt to move the uprooted plants rearward from the harvesting head; and
making at least two cuts along a length of the uprooted plants with a cutting system of the harvesting machine to form the cut portions.

19. The method according to claim 18, further comprising separating a first type of the cut portions of the plants from a second type of the cut portions and moving at least one of the first type and the second type of the cut portions to one or more containers.

20. The method according to claim 19, wherein the separating comprises separating a third type of the cut portions of the plants.

21. The method according to claim 18, further comprising moving a first type of the cut portions of the plants away from the main body and into a first container and moving a second type of the cut portions of the plants away from the main body.

22. The method according to claim 18, further comprising loosening soil with the harvesting head prior to pulling the roots of the plants from the soil.

23. The method according to claim 22, wherein the loosening comprises loosening soil with tines extending from a roller of the rotating structure.

24. The method according to claim 18, further comprising vibrating the roots of the plants with a vibrating component coupled to the harvesting machine to remove the soil from the roots.
